(19) United States
(12) Patent Application Publication
(10) Pub. No.: US 2004/0048232 A1
(43) Pub. Date: Mar. 11, 2004

(54) Method and apparatus for internet based management of compliance distribution and training

(76) Inventors: Elizabeth Ann Murphy, Washington, DC (US); Patrick Joseph Murphy, Washington, DC (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/424,835

(22) Filed: Apr. 29, 2003

Related U.S. Application Data
(63) Continuation of application No. 09/675,155, filed on Sep. 29, 2000.

(51) Int. Cl. G09B 7/00

(52) U.S. Cl. 434/322; 434/219

(57) ABSTRACT

A method for a server to provide professional training information and compliance knowledge information to networked computers. The method obtains login data from a user at a computer. The user is provided compliance knowledge based on the login data. The user is also provided personalized professional training associated with the compliance knowledge and based on the login data. Compliance use data, training performance data and training progress data associated with login data is generated. The generated data is used for the generation of documents. The system provides compliance management to a user having administrative privileges. The system enables communication between users of the system.

### FIELD OF THE INVENTION

The present invention relates to a computer-implemented method and system for information distribution and training. More particularly, the present invention relates to an Internet based platform for managing the distribution of compliance knowledge and training of professional employees of a business entity.

### BACKGROUND OF THE INVENTION

There are a number of organizations, institutions, and companies that engage in providing various goods and services to consumers. These business entities may include banks, financial service institutions, insurance companies, pharmaceutical companies, food companies and law firms. Often providing these goods and services requires that professionals employed by the business entities have a minimum amount of industry knowledge, knowledge of the business entity, and skills so that customers can be provided with a competent level of service as well as the most accurate, up to date industry information and products. Accordingly, various regulatory agencies exist which govern the industries in which these entities do business. These agencies develop guidelines and rules to protect the customers, and which the business entity and the licensed professionals employed by the business entity must follow. Failure to adhere to the guidelines and rules established by these agencies can result in an organization being severely sanctioned, fined, and or a party to a litigation.

To prevent or mitigate the issuing of any sanctions and or commencement of litigation, these business entities must demonstrate to the agencies that govern their respective industries that they are adhering to the rules and guidelines. More specifically, these business entities must demonstrate that they and their professional employees are performing job functions within the parameters promulgated by the agency guidelines. Often demonstrating that the rules and guidelines are being followed requires that a business entity provide an agency with reports and other materials that convey what activities and training the professionals employed by the business entity has received. Production of these reports protects and strengthens a business entity's defensive position against litigation and sanctions by regulatory agencies and consumers.

However, performing the necessary tasks to comply and demonstrate compliance with the rules and guidelines is often an arduous task. The generation of the requisite reports is one such task. These reports are tedious, time consuming, and difficult to generate. They require identifying and tracking the activities of individual professional employees as well as groups of professional employees, such as the professional employees for a branch of a business entity, to obtain the data to be included in the reports.

Providing and tracking the training required by the rules and guidelines is also as difficult a task. Often providing training to professional employees will reduce there work output since the employees will be taken away from their work for a considerable amount of time. In addition, employees will be less likely to engage in training that requires the employees to travel to a location other than their place of employment. Furthermore, employees who do engage in training on and off the work location may have poor organizational skills, and thus, not keep accurate record of their training.

Accordingly, there exist a need in industries that are highly regulated for a method and system that provides information deemed necessary by the agencies to the employees of these companies. There also exist a need in these industries for tracking an employee's interaction with the provided information. Lastly, there exists a need in these industries for organizing and recording the employee's activity with the provided information.

### SUMMARY OF THE INVENTION

Based on the above and foregoing, it can be appreciated that there presently exists a need in the art for a computer system and corresponding operating method which overcomes the above-described deficiencies. The present invention was motivated by a desire to overcome the drawbacks and shortcomings of the presently available technology, and thereby fulfill this need in the art.

The present invention is a method, system, and computer program product for managing and tracking the distribution of compliance knowledge and training to licensed professionals of an organization. The present invention provides an organization engaging in a government regulated activity with a management system and method for organizing, delivering and monitoring compliance knowledge and professional training. The management system provides services that may include compliance knowledge distribution, professional training, management administration, communication, and reference resource distribution.

In an aspect of the present invention, a user can be provided with access to compliance knowledge. The compliance knowledge can include various compliance knowledge types. Each listed type corresponds to a link that, when selected, leads to the segment of information for the type. The user may access a knowledge type to obtain information that the user desires to use and obtain knowledge from. The user can access various sections of the knowledge typed. The knowledge type can include descriptive content that can convey information that is required to professional employees and that can provides knowledge necessary for performing a job function competently. The user may navigate from within the knowledge type using navigation controls.

In an aspect of the present invention, there can be various forms of compliance knowledge. Each form of compliance knowledge can be customized to benefit a specific business entity. A professional employee of the business entity can access the form of the compliance knowledge that corresponds to the business entity for which the employee works.

In another aspect of the present invention, access to the compliance knowledge can be determined by login data. The login data can be associates with a profile that can enable the identification of the appropriate compliance knowledge for a user.

In another aspect of the present invention, the use of compliance knowledge by a user can be recorded and stored as data for use in the future. An administrator, such as manager, can access the stored data for use in generating of documents. The documents can be useful in reducing organizational risks.

In another aspect of the present invention, a user can access professional training subject matter. The personalized training can be customized to a user's role and job functions, professional licenses, business entity of employment, and that satisfy any professional training requirements established by respective regulatory agencies. The personalized training can be provided as various courses and each course can include various lessons. The lessons can include instructional information and interactive exercises pertaining to the topic of the lesson.

In another aspect of the present invention, the lesson can include various modes of instruction. Each mode of instruction can teach subject matter related to the lesson in a different manner.

In another aspect of the present invention, access to the professional training can be determined by login data. The login data can be associates with a profile that can enable the identification of the appropriate professional training for a user.

In another aspect of the present invention, the use of professional training as well as user progress and user performance of a user can be recorded and stored as data for use in the future. An administrator, such as a manager, can access the stored data for use in generating of documents. The documents can be useful in reducing organizational risks.

In another aspect of the invention, the professional training and compliance knowledge can be associated. The associating can allow a user to access compliance knowledge when performing professional training. The association can also allow a user to access professional training when using compliance knowledge.

In another aspect of the present invention, a communication dialog can be performed. A communication link can initiate the communication dialog. The dialog may be performed in various manners. The communications dialog enables discussion between the user and other professional employees of the business entity to discuss professional training.

In another aspect of the present invention, a user can perform compliance management administration. The system can implement the functions of administrative service. The functions may include user registration and profile creation, notification, and information creation and distribution.

In another aspect of the present invention, access to compliance management administration can be determined by login data. The login data can be associates with a profile that can enable the identification of whether the user is authorized to perform management functions.

Further features and advantages of the invention will become apparent to those skilled in the art with reference to the accompanying figures and written description below.

### BRIEF DESCRIPTION OF THE DRAWINGS

The details of the present invention, both as to its structure and operation can best be understood by referring to the following description with reference to the accompanying drawings in which:

FIG. 1 is a diagram of a system in which the method of the present invention can be carried out;

FIG. 2 is a functional block diagram of a system server computer in the network of FIG. 1, used by a business entity for managing the distribution of compliance knowledge and professional training;

FIG. 3 is a functional block diagram of business entity computer in the network of FIG. 1, used by licensed professionals of business entity, in which the method of the present invention can be practiced;

FIG. 4 is a flow diagram depicting a method of user login;

FIG. 5 is an exemplary screen for user login;

FIGS. 6A-6B is a flow diagram for the method of compliance knowledge distribution;

FIG. 7 is an exemplary screen for listing various compliance knowledge types;

FIG. 8 is an exemplary screen for listing various sections of a compliance knowledge type;

FIGS. 9A-9B depict exemplary areas of a web page providing a section of information;

FIGS. 10A-10B is a flow diagram depicts the process of professional training;

FIG. 11 is an exemplary personalized training page;

FIG. 12 is an exemplary course contents page;

FIG. 13 is an exemplary training lesson web page is depicted;

FIG. 14 is a flowchart depicting the method of initiating a communication dialog performed by the present invention;

FIGS. 15A-15B is a flow diagram depicting the process of distributing compliance reference resources;

FIG. 16 is an exemplary screen for listing various reference resource types; and

FIG. 17 is a flow diagram depicting the process of compliance management administration.

### DETAILED DESCRIPTION OF THE INVENTION

The present invention is now described more fully hereinafter with reference to the accompanying drawings that show preferred embodiments of the invention. This invention, however, may be embodied in many different forms and should not be construed as limited to the embodiments set forth herein. Appropriately, these embodiments are provided so that this disclosure will be thorough, complete, and will fully convey the scope of the invention.

As will be appreciated by one having skill in the art, the present invention may be embodied as a method, a data processing system, a computer program product and a method of doing business. The present invention combines software and hardware to produce the embodiments of the present invention described in further detail below. Furthermore, the present invention may take the form of a computer program product on a computer-readable storage medium having computer-readable program code means embodied in the medium. Any suitable computer-readable medium may be utilized including hard disk, CD-ROM, floppy disk, optical storage device, magnetic storage device, etc.

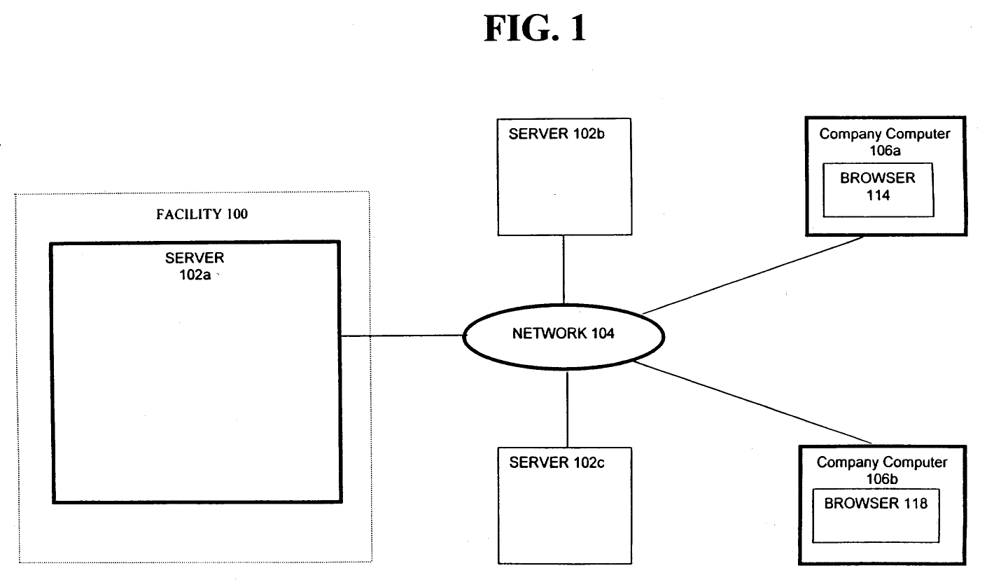

Referring now to FIG. 1, a functional block diagram of Facility 100 is depicted in which the present invention can be performed. As shown in FIG. 1, various computers 106 can connect to network 104. These computers 106 can communicate with Facility 100 via computer network 104. In the preferred embodiment, a compliance management service provider, at a location remote to business entities, operate the Facility 100. The Facility 100 can implement the methods and functions of a web based management platform for compliance knowledge distribution and professional training for various business entities. Computer devices 106 can connect to Facility 100 server 102a using network 104. Professional employees of the various business entities can use computer devices 106 to access the methods and functions of a web based management platform for compliance knowledge distribution and professional training.

In an alternative embodiment, a business entity can operate Facility 100. Facility 100 can implement the methods and functions of a web based management platform for compliance knowledge distribution and professional training solely for its own benefit. Computer devices 106 can connect to Facility 100 server 102a using network 104. Professional employees of the business entity can use computer devices 106 to access the methods and functions of a web based management platform for compliance knowledge distribution and professional training. The Facility 100 may transmit, using network 104, any combination of proprietary voice, video and/or data between computer devices 106 and Facility 100 server 102a.

In the preferred embodiment, the network 104 of the present invention may be a wide area network (WAN), such as an Internet. The Facility 100 may connect to third party server devices 102b and 102c using network 104. Third Party server devices 102b and 102c can contain information and services that are external to and compliment the information and services available on server 102a at Facility 100. As will be appreciated by one of skill in the art, a number of computer devices 106 may be provided at disparate locations throughout the network 104. In an alternative embodiment, the network 104 of the present invention may be a local area network (LAN), such as an Intranet. The Facility 100 may connect to third party server devices 102b and 102c using a local area network.

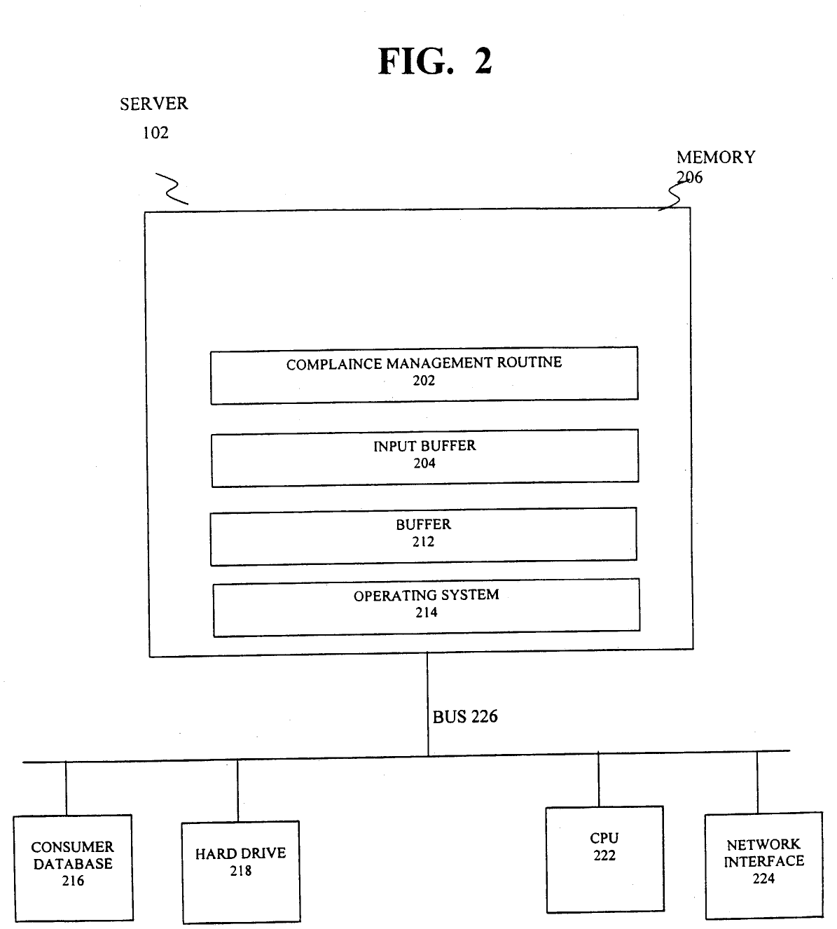

FIG. 2 is a functional block diagram of server device 102a illustrated in FIG. 1. The server devices 102 may include a central processing unit (CPU) 222, connected by a bus 226 to a memory 206, a consumer database 216, a hard drive 218 and a network interface 224 which can be connected to networks 104 for communication with computer devices 106. The server devices 102 may include the software for implementing a web based compliance management platform for knowledge distribution and training to professionals of a business entity. As shown, the various components of the server devices 102 communicate through a system bus 226 or similar architecture. Typically, CPU 222 can be a microprocessor, such as an INTEL PENTIUM® processor, but may also be any processor that executes computer program instructions.

Systems memory 206 can be disposed in communication with CPU 222 and database 216. In the preferred embodiment, the communication is through bus 226. Memory 206 may include Compliance Management routine 202, an input buffer 204, a buffer 212, and operating system 214. Systems memory 206 is the workspace from which all program execution and data processing takes place for server device 102.

Compliance Management routine 202 may be computer program instructions executable by CPU 222, which may be loaded into systems memory 206. Compliance Management routine 202 includes functions that implement, as described in detail hereinafter, user login, compliance knowledge distribution, professional training, training administration, and compliance tracking. Compliance Management routine 202 may be stored on computer readable media and used therefrom by server device 102a to perform the specified functions.

The personal profile buffer 212 and input buffer 204 can serve as reserved areas of memory for temporarily holding data. The buffer 212 may hold data retrieved from consumer database 216 until it is ready for processing. Input buffer 204 may hold data transmitted from computer device 106 and servers devices 102b and 102c over networks 104 to server device 102a.

Operating system 214 provides overall system functionality. Operating system 214 is the program that, after being initially loaded into the computer, manages all the other programs in server 102, such as Compliance Management routine 202. The operating system 214 can find data and delivers it to Compliance Management routine 202. Conversely, when Compliance Management routine 202 is ready to output, the operating system 214 can transfer the data from Compliance Management routine 202 to the appropriate destination. The operating system 214 is responsible for the central management of all devices, not just disk drives. The operating system 214 can call on one or more drivers for input and output, and the drivers communicate with the corresponding hardware device.

Network Interface 224 can enable communication between servers 102 and computers 106 using network 104. It receives data from and transmits data to computer devices 106. Database 216 can be in communication with server 102 using bus 226. The database 216 can include documents, information content and data. The database 216 can be particularly useful for holding information generated from interaction between server 102 and computer 106.

In the preferred embodiment, the database 216 stores compliance knowledge, professional training information, document and data. The compliance knowledge, professional training information, document and data are specific to a business entity using the system 100. The available compliance knowledge, professional training information, document and data can be provided in a format that can be understood by browser 308, such as HTML or XML. The compliance knowledge, professional training information, document and data can be stored as segments of information that can be accessed at once. Each segment of information that can be accessed at once corresponds to a web page and has an associated network address identifying the location of the segment in the database 216. A web page can be presented to the user by referencing the address of the segment of information. A collection of information segments that are related to a common topic may be connected with one another using links (i.e., hyperlinks) that reference the address of other segments. The collection of information segments may all be stored on server device 102a or may dispersed between server devices 102a-102c. Compliance knowledge stored in database 216 may include manuals, updates, guides, and firm element plan.

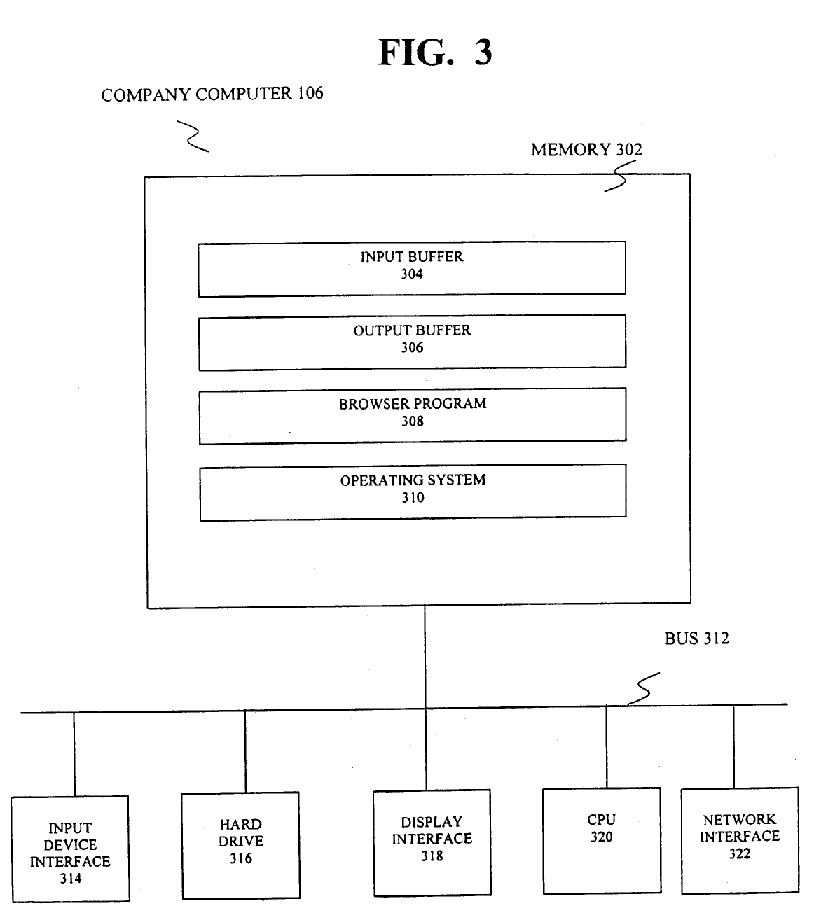

FIG. 3 is a functional block diagram of a computer device 106 as illustrated in FIG. 1. The computer device 106 can enable employee employed by a business entity to view information content provided by various server devices 102a-102c. In the preferred embodiment, computer device 106 may include personal computers, workstations and the like. Computer device 106 may include a central processing unit (CPU) 320, connected by a bus 312 to the memory 302, a hard drive 316 and a network interface card 322 which can connect to network 104 for communication with server devices 102a-102c. Computer device 106 can also include input device interface 314, and display interface 318. Input device interface 314 enables interaction with and execution of instruction by a user of computer device 106. Display interface 318 displays information generated for output by computer device 106 and provided by server devices 102a-102c. The information may be in the form of web pages that provide the user with the methods performed by server device 102. Systems Memory 302 can store data, such as Browser Program 308, an input buffer 304, an output buffer 306, and operating system 310.

Browser Program 308 is a computer program that can be executed by CPU 320 and that may be loaded into systems memory 302. The browser program 308 enables the information content available at server devices 102 to be provided to computer device 106 in a manner that can be understood by a user. The browser 308 serves as a front end to the World Wide Web on the Internet and is designed to display one web page at a time.

The present invention is a method, system, computer program product and business method for managing the distribution of compliance knowledge and professional training information to employees of a business entity. The present invention provides a business entity engaging in a government regulated activity with a management system and method for organizing, delivering and tracking compliance knowledge and professional training information distribution. Compliance Knowledge as used herein is meant to convey segments of information content available at a server that relates to the performing a job function as defined by a regulatory agency and business entity. In the preferred embodiment, Facility 100 can include many variations of compliance knowledge and professional training information. Each variation, for example, is customized to fulfill the needs of a specific business entity. In an alternative embodiment, Facility 100 can include compliance knowledge customized for a single business entity.

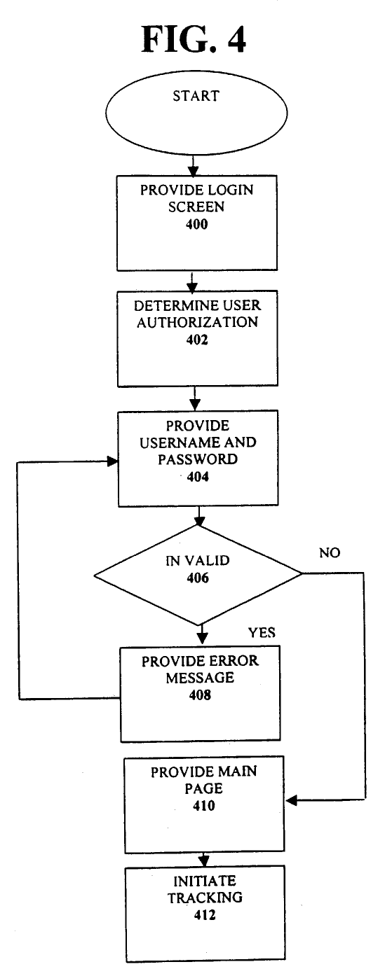

Turning now to FIG. 4. FIG. 4 depicts a flowchart illustrating a method of user login. In the preferred embodiment, the method of user login provides a user with access to information content and services provided by Facility 100. The information content to which access can be granted includes Compliance Knowledge and professional training information. In step 400, a user, such as a professional employee of the business entity, can connect to server device 102a using computer 106. Server 102a can provide the user with a login screen upon connecting to computer 106. In order to access the full functionality of server 102a, authorization may be necessary. In step 402, the server device 102a can determine authorization.

In step 404, the entry of login data can be made. In the preferred embodiment, the login data includes a username and password. Server 102a can transmit the login data over network 104 from computer device 106. In step 406, the server 102a can validate the login data. In the preferred embodiment, validation determines access rights to the site, what form of compliance knowledge as well as professional training information to provided the user, and the pace at which the training will occur. A user's distinct profile can be utilized in the validation process. Login data is associated with a distinct profile. The distinct profile can define access rights and training courses required. The distinct profile can be created during the registration of the user. The registration can be performed by a business entity administrator or the user, and can be based on the user's job functions within the business entity and any professional licenses held. If the username and password entered are incorrect or nonexistent, in step 408 an error message can be displayed and the user prompted to repeat the login procedure or contact an administrator to be registered. If the username and password entered are correct, in Step 410 the user can be provided with an interface for access to the services and information content available on server device 102a.

In the preferred embodiment, the interface is a main page by which a user can gain access to the services and information content provided by server device 102a, such as Compliance Knowledge and profession training information. The Main Page can include a listing of the services available on the server device 102a. In the preferred embodiment, the available services include compliance knowledge distribution, professional training information, compliance management administration, compliance communication, and reference resource distribution. The methods performed by these services are described in further detail herein below.

In Step 412, the tracking method can be initiated. In the preferred embodiment, the tracking method operates in concert with the compliance knowledge and/or professional training information distribution. The tracking method can monitor the use, such as viewing, of compliance knowledge by a user as well as the performance and progress of the user engaged in professional training course. For example, the system monitors the user selection of compliance knowledge and sections thereof by the user as well as the responses to interactive exercises. The tracking method generates compliance knowledge use data associated with use of the compliance knowledge. The tracking method also generates personal training activity data associated with use of the personalized professional training information. All relevant data can be recorded. In the preferred embodiment, the data is stored and associated with the login data.

The data can be used for the generation of meaningful documents. In the preferred embodiment, the documents are reports that can demonstrate that the professional employees of a business entity know what the proper procedures are for performing their job function and how to apply the procedures. In the preferred embodiment, the relevant data includes compliance knowledge used, training courses taken, training progress, training exercise scores, and data indicating the time and date that the data was generated. The recorded data may be stored in database 216, for example, as a record associated with the user having the username and password. New data can be appended to any previously recorded data so as to generate a compliance log or history for the user.

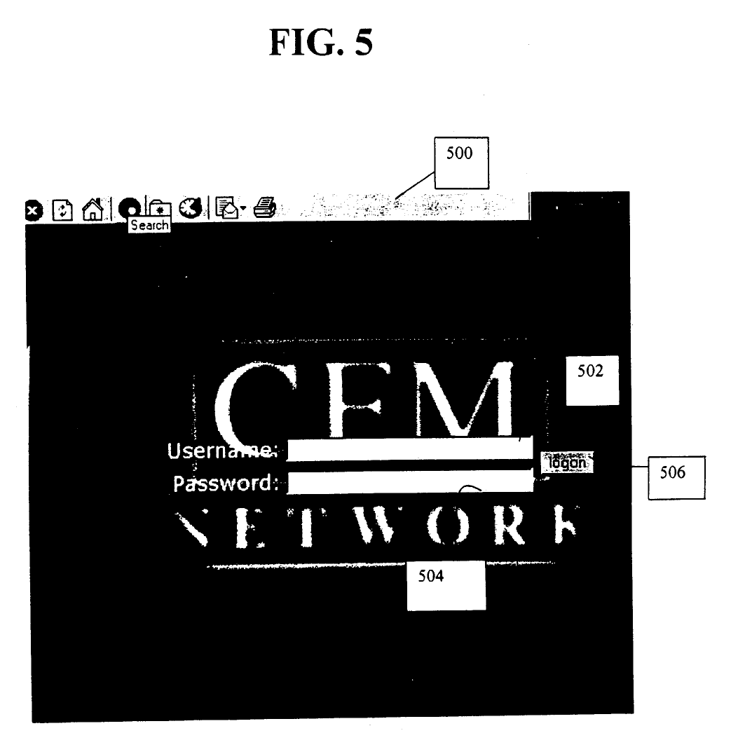

Turning now briefly to FIG. 5. FIG. 5 is an exemplary login web page 500. The login web page includes a field for a user to provide their username 502 and a field for their password 504. The username and password grants a user access to the services provided by server 102a when login button 506 is selected.

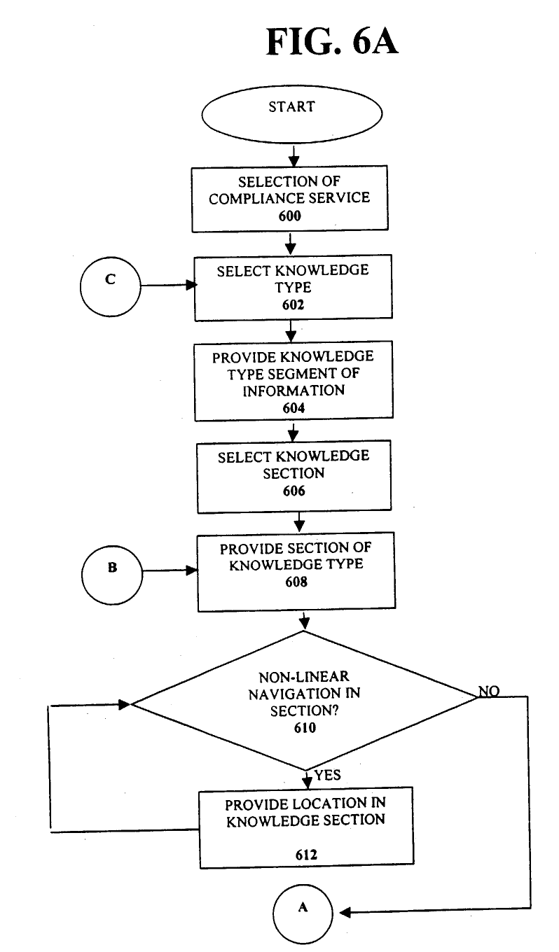

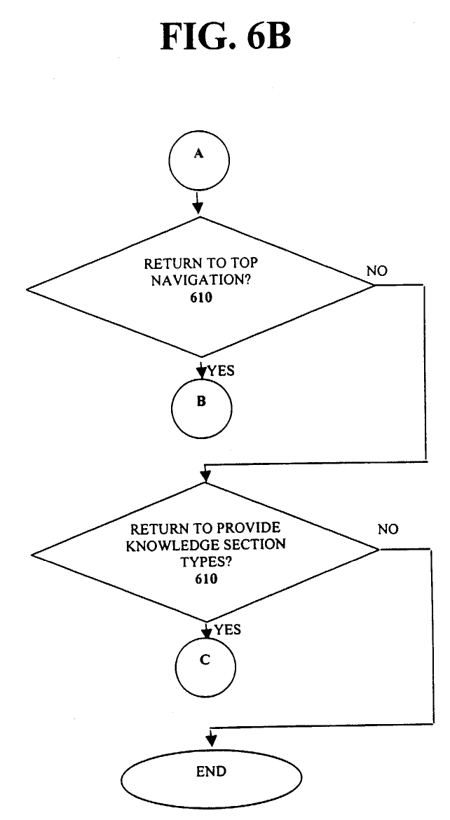

Turning now to FIG. 6, where a flow diagram depicts the process of distributing compliance knowledge. In Step 600, the process begins in response to a user request for a service. In the preferred embodiment, a user selects the compliance service listed on the Main Page. Each listed service can be a link that, when selected, leads to compliance knowledge stored in database 216 of server device 102a. The selection of the compliance service provides a user with the segment of information for the compliance knowledge. In the preferred embodiment, the segment of information is in the form of a web page. The web page includes a list of various compliance knowledge types. Server device 102a can transmit the segment of information including the listing of knowledge types, over network 104, to the computer device 106.

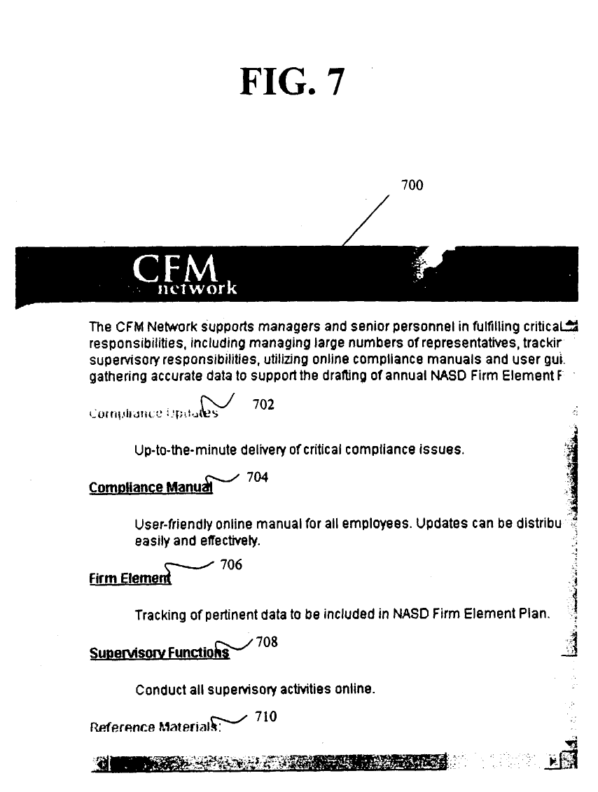

Turning now briefly to FIG. 7. FIG. 7 is an exemplary screen for listing various compliance knowledge types. In the preferred embodiment, the knowledge types listed include manual update 702, compliance manual 704, supervisory manual 706, firm element plan 708 and references 710. Each listed knowledge type may be a link or refers to links that, when selected, leads to a corresponding segment of information that includes the descriptive text related to issues addressed by the knowledge type.

In the preferred embodiment, manual update type 702 pertains to a segment of information related to updates in the general policies and procedures for performing job functions as promulgated by a regulatory agency and supervising the professionals of a business entity performing the job functions. Compliance manual 704 pertains to a segment of information related to general policies and procedures for performing job functions as required by a regulatory agency. Supervisory manual type 706 pertains to a segment of information related to general policies and procedures for supervising the professionals of a business entity performing the job functions and any relevant reports. Firm element plan type 708 pertains to a segment of information related to assessment reviews. Reference type 710 pertains to segments of information that is relevant and supplements any of the aforementioned knowledge types. The reference segments of information may include Sales, Product, Best Practices, Down Market Contingency Plan, Compliance, Account Guidelines, Sales Practice, and Policies and Procedures.

Returning now to FIG. 6. In Step 602, the user can select a knowledge type. Selection is a designation of an item of interest. In the preferred embodiment, the selection is a link that corresponds to the knowledge type segment of information that the user desires to use and learn about. The computer device 106 can transmit selection over network 104 to server 102a using network interface 322.

In Step 604, the server 102a can transmit a portion of segment of information to the computer device 106. The segment of information corresponds to the selected knowledge type. In the preferred embodiment, the portion of the segment of information is provided to the user as a web page. The web page may include a list of various sections that relate to specific issues discussed in the knowledge type segment of information.

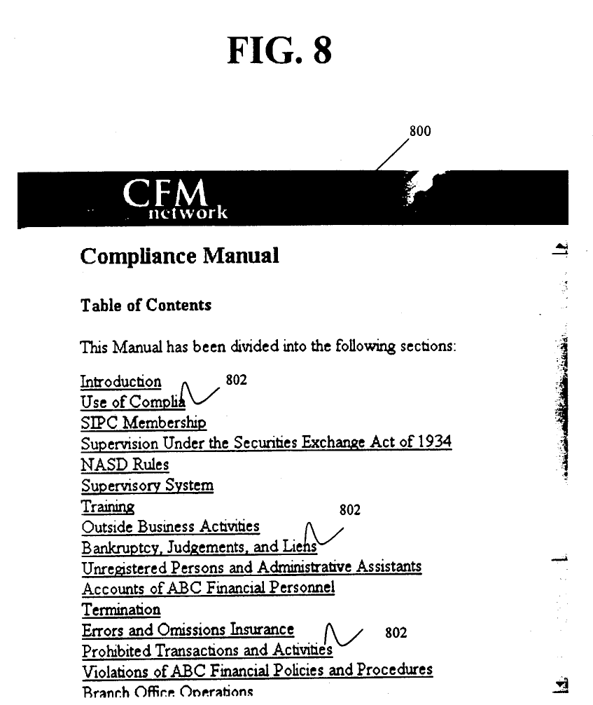

Turning briefly to FIG. 8. FIG. 8 is an exemplary screen for listing various sections of a compliance knowledge type 802. The section listings are in the form of a table of contents. The sections pertain to the rules and guidelines of a regulatory agency. Each listed section corresponds to a link that, when selected, leads to a section of information located within the segment of information for the knowledge type selected in Step 600.

Returning now to FIG. 6. In Step 606, the user can select a section of a compliance knowledge type. Selection is a designation of an item of interest. The selection reflects the user's desire to use and learn the specific issue discussed by the section of the knowledge type. The selection is transmitted to server 102a as a request over network 104.

In Step 608, the server 102a can provide the user with the section of information that is associated with the selected link for a section of a compliance knowledge type. In the preferred embodiment, the section of the information is provided as a web page. The web page includes an area for the descriptive compliance content, an area with links for navigating within the section of information, an area with a link for returning to the top of the web page for the section and the web page, and an area with a link for returning to the web page for selecting a section of a knowledge type. The server 102a can transmit the web page over network 104 to a computer device 106 for display on display 318.

The area for the descriptive content may include descriptive text with regulatory links, reference links and training links embedded therein. The descriptive text can convey the information that provides a professional with the knowledge necessary for performing a job function. The Regulatory links can retrieve segments of information stored on an external server device, such as 102b and 102c, which the descriptive text is based. In the preferred embodiment, the segments of information retrieved from external server device 102b and 102c will be stripped of links referring to other segments of information. In addition, the external server 102b-102c are associated with or operated by a regulatory agency. Training links can retrieve training segments of information stored on server device 102a that include interactive exercises based on the descriptive text surrounding the embedded training link. Reference links can retrieve reference segments of information from server device 102a that are relevant and supplement the descriptive text surrounding the embedded reference link.

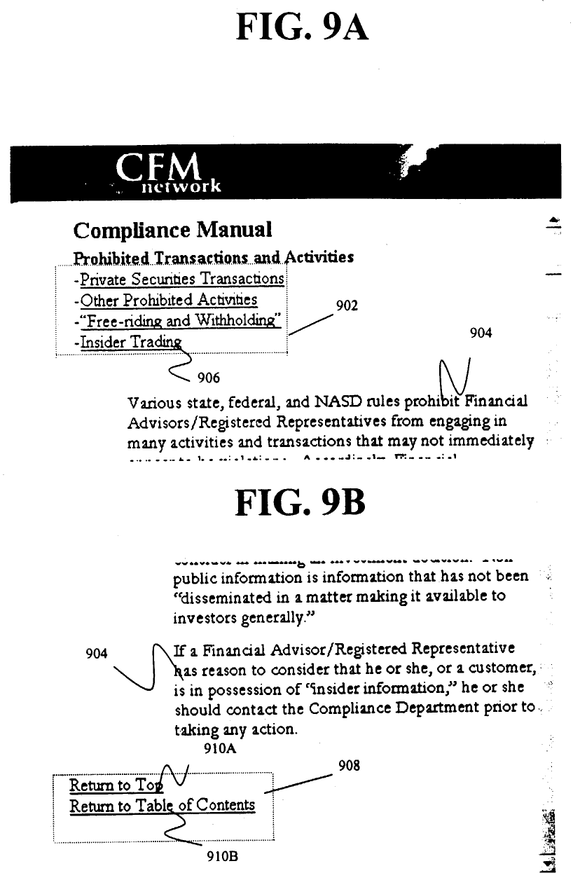

Turning to FIGS. 9A-9B briefly. FIGS. 9A-9B depict exemplary areas of a web page providing the section of information. FIG. 9A depicts the area with links for navigating within the section of a compliance knowledge type 902 and the area for providing the descriptive content 904. Links 906 correspond to the subjects covered by the section. FIG. 9B depicts the area 908 with link 910a for returning to the top of the web page for the section and link 910b for returning to the web page for selecting a section of a knowledge type.

In Step 610, the server 102a can determine navigation initiated within the section of information. In the preferred embodiment, initiating navigation is accomplished through the selection of the links provided in the areas discussed above in FIGS. 9A-9B. If the server 102a determines that the navigation is for returning to the top of the section the process returns to Step 608 where the web page providing the descriptive content is again provided. If the server 102a determines that the navigation is for navigating within the section of a compliance knowledge type the server moves to the location of information within the section of compliance knowledge Step 612 and then returns to Step 610. If the server 102a determines that the navigation is for returning to the web page for selecting a section of a knowledge type the process returns to Step 602.

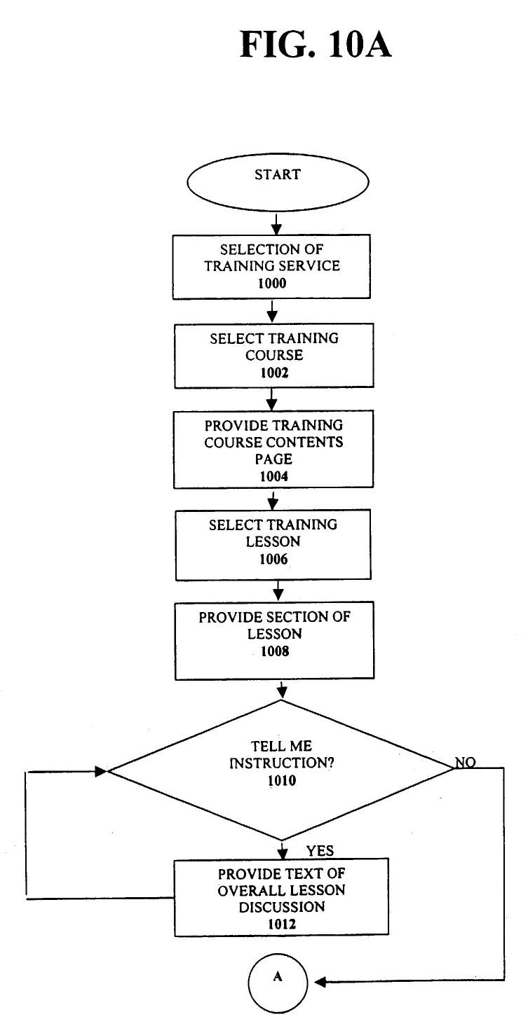

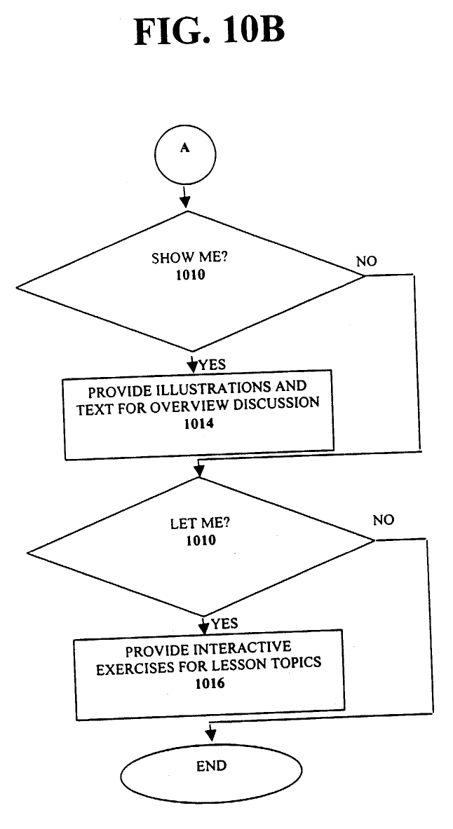

Turning now to FIG. 10, where a flow diagram depicts the process of professional training. In Step 1000, the process begins in response to a user request for training service. The request can be a link included on the Main Page discussed above. In the preferred embodiment, the user is provided with a personalized training page. The training page will include a listing of at least four (4) distinct training courses that are customized to a user's role and job functions as a licensed professional of the business entity, and that satisfy any training requirements established by the respective regulatory agencies for any professional licenses held. The training courses will be assigned a course track that determines the pace at which the instruction will occur. The course track can include fast and slow. The training page is transmitted from server 102a over network 104 to a computer device 106.

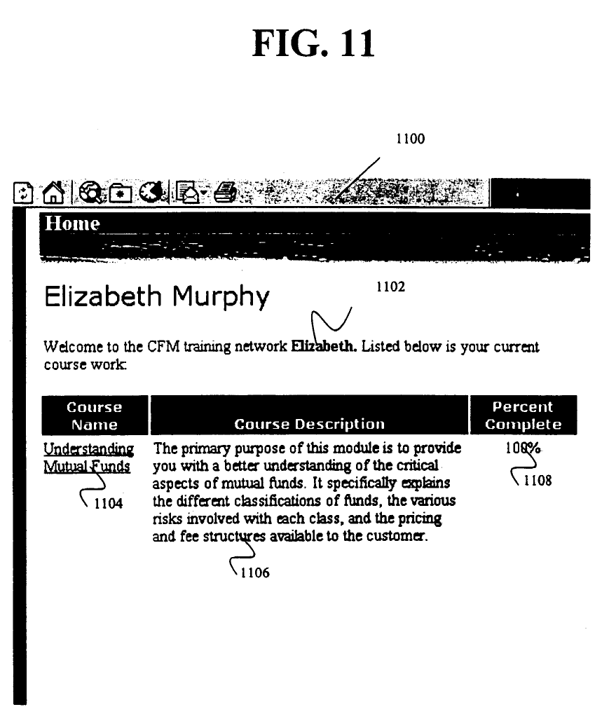

Turning briefly to FIG. 11. FIG. 11 is an exemplary personalized training page 1100. The training page can include a user identifier 1102, a list of courses 1104, course descriptions 1106 and course completion indicator 1108. The user identifier reflects the user who is logged in to the server 102a. The list of courses corresponds to the training that the user is required to receive to fulfill requirements as a licensed professional and deemed necessary by the business entity. Each course listed has an associated course description that conveys the primary purpose of the course. Each course listed also has an associated course completion indicator that specifies the percentage of the course that has been completed by the user to date.

Returning now to FIG. 10. In Step 1002, the user can select a training course. In the preferred embodiment, the user selects a link that corresponds to the particular training that the user desires to receive. The selection is transmitted from computer device 106 over network 104 to server 102a using network interface 322.

In Step 1004, the user can be provided with course contents. The course content can be provided as a web page. In the preferred embodiment, the course contents web page includes a listing of course lessons that are part of the course training. Each course lesson covers a different topic that is related to the subject matter of the course. The content page provides a user with access to the courses listed. The course contents page is transmitted from server 102a over network 104 to computer device 106.

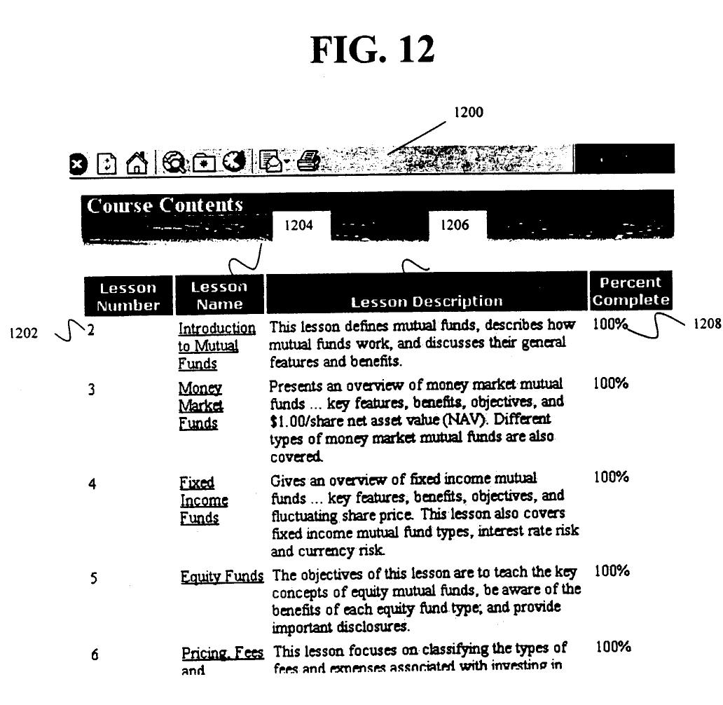

Turning briefly to FIG. 12. FIG. 12 is an exemplary course contents page 1100. The course contents page includes lesson numbers 1202, a list of lesson 1204, lesson descriptions 1206 and lesson completion indicator 1208. The lesson number is a representation of the order in which the lesson occurs with respect to the other lessons in the course. The list of lessons corresponds to topics covered by the course. Each lesson listed has an associated lesson description that conveys the primary purpose of the lesson. Each lesson listed also has an associated lesson completion indicator that specifies the percentage of the lesson that has been completed by the user to date.

Returning to FIG. 10. In Step 1006, the user can select a training lesson. In the preferred embodiment, the selection can be a link that corresponds to the particular training topic that the user desires to receive instruction. The selection is transmitted from computer device 106 over network 104 to server 102a using network interface 322.

In Step 1008, the server 102a can provides the user with the section of information that is associated with a selected lesson. In the preferred embodiment, the selected lesson is provided as one or more web pages. Each web page provides the user with instructional information and interactive exercises pertaining to the topic of the lesson.

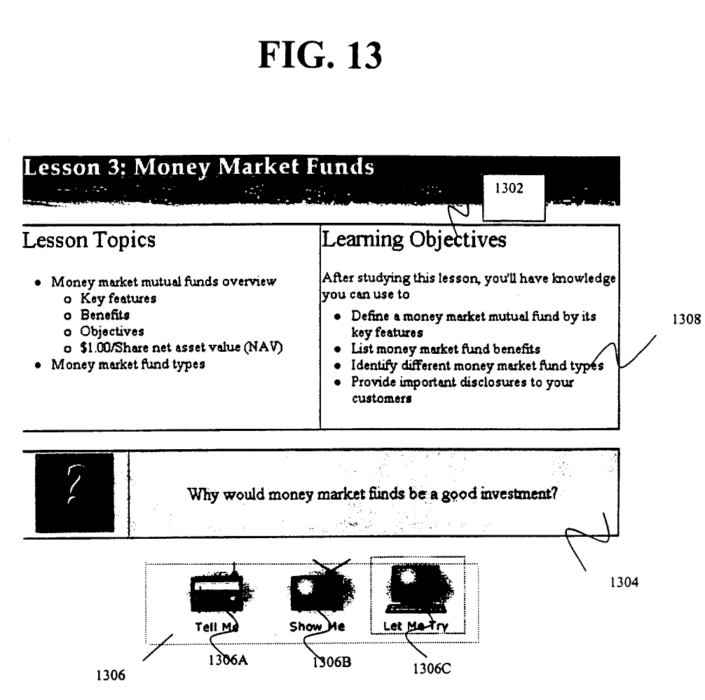

Turning now to FIG. 13, where an exemplary training lesson web page is depicted. The web pages includes an area for the descriptive lesson content 1302, an area for challenge content 1304, an area for interactive icons 1306, links embedded in the text of descriptive lesson content 1308, and navigation controls 1310. The web page is useful for the delivery of interactive training content.

In the preferred embodiment, descriptive lesson content area 1302 is a region of text provided on the web pages that teaches the principles and addresses the issues pertaining to the topic of the lesson. The challenge content area 1304 is a region of the web page that presents the user with a question that pertains to the topic of the lesson. The interactive icon area 1306 is a region of the web page that includes icons that dictate the section of the lesson given and mode of instruction. The Tell Me icon 1306a retrieves a section of the lesson that provides instruction as an overall discussion of the topic that can be used in performing a job function. The Show Me icon 1306b retrieves a section of the lesson gives instruction as an overview of a particular issue associated with the topic. The Let Me Try icon 1306c retrieves a section of the lesson that provides instruction by allowing the user to provide responses to question related to the topic.

The links embedded in the descriptive lesson content area 1308 may include a help link, a communication link, a reference link and a hints link. In the preferred embodiment, the help link provides a section of information that gives a user the knowledge necessary to use the training service. The communication link initiates a communication dialog between the user and other professional employees of the business entity (described in further detail herein below). The reference link provides a segment of information that supplements the lesson content. The hints link provides a segment of information that assists a user in issuing a response to questions.

Returning to FIG. 10. In Step 1010, the server 102a can determine the mode of instruction. In the preferred embodiment, initiating the mode of instruction is accomplished through the selection of the icons. The icons can be provided in the interactive icon area 1306 discussed above in FIG. 13. If the server 102a determines that the mode of instruction is the Tell Me mode of instruction the process proceeds to Step 1012 and can provide an overall discussion of a topic. In the preferred embodiment, the overall discussion is provided as a web page including text for an overall discussion of the topic that is used in performing a job function. If the server 102a determines that the navigation is for the Show Me mode of instruction process proceeds to Step 1014 and can provide an overview of a particular issue. In the preferred embodiment, the overview of the particular issue is provided as a web page that includes text and illustration for an overview of a particular issue associated with the topic. If the server 102a determines that the navigation is for the Let Me mode of instruction the process proceeds to Step 1016 and can provide interactive exercises. In the preferred embodiment, the interactive exercises are provided as a web page that allows the user to respond to interactive exercises and assessment questions designed to ascertain knowledge and ensure retention related to the topic. Each of the web pages, provided in Steps 1012-1016, may include navigation icons in a navigation area. The navigation icons allow the user to retrieve the next web page in the respective mode of instruction for the lesson.

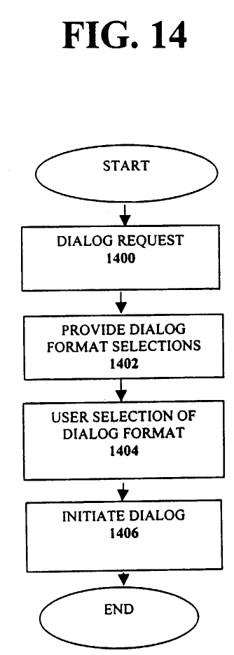

Turning now to FIG. 14. FIG. 14 is a flowchart depicting the method of initiating a communication dialog performed by the present invention. In Step 1400 the process begins in response to a communication dialog request. In the preferred embodiment, the request is initiated by the selection of a communication link, such as communication service link listed on the Main Page and the communication link embedded in descriptive lesson content area discussed above. The request initiates a dialog between the user and other professional employees of the business entity to discuss training courses and training lessons. The request is transmitted from computer device 106 over network 104 to server 102a.

In Step 1402, the user is provided various forms of communication. In the preferred embodiment, the various form of communication are provided in a web page as a list of links. The listed forms of communication may include an e-mail communication, scheduling an on-line meeting and participation in a discussion group. The web page listing the various forms of communication is transmitted from server 102a over network 104 to computer device 106.

In Step 1404, the user can select a form of communication. The selected form of communication reflects the type of dialog that the user wishes to engage in order to obtain assistance. The selection is transmitted from the computer 106 over network 104 to server 102a.

In Step 1406, the server 102a can initiate the dialog in accordance with the selection in Step 1404. In the preferred embodiment, if the selection is for e-mail communication the server 102a launches the business entities' e-mail application allowing the user to send an e-mail message requesting assistance. If the selection is for a discussion group the server 102a connects a user to a discussion group focusing on the topic for which assistance is needed. If the selection is for scheduling a meeting the user is provided a calendar to plan a conference.

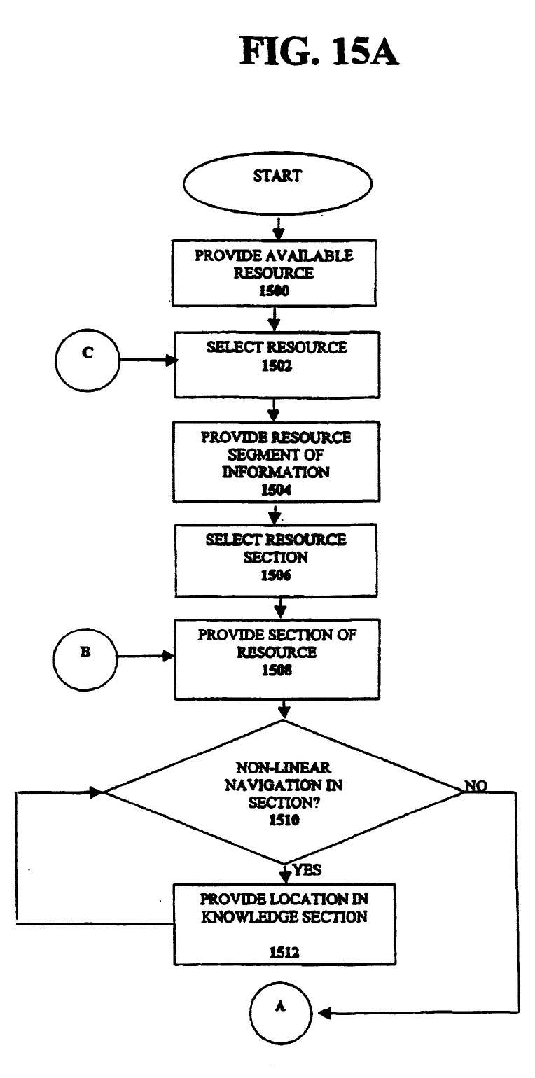

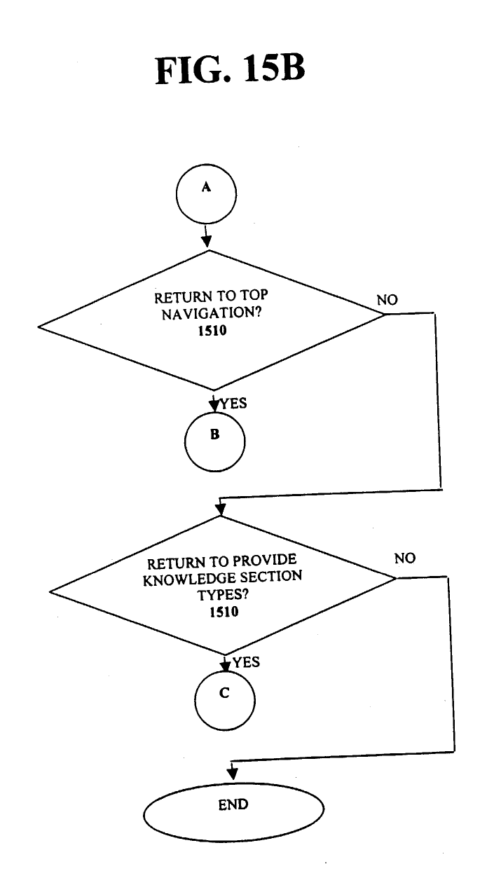

Turning now to FIG. 15, where a flow diagram depicts the process of distributing compliance reference resources. In Step 1500, the process begins in response to a user accessing a reference service. In the preferred embodiment, the user selects a reference service link listed on the main page. The selection of the reference service link provides a user with a segment of information in the form of a web page that includes a list of various reference resource types. The segment of information is retrieved by server 102a from database 216. Server device 102a transmits the segment of information including the listing of knowledge types, over network 104 to the computer device 106.

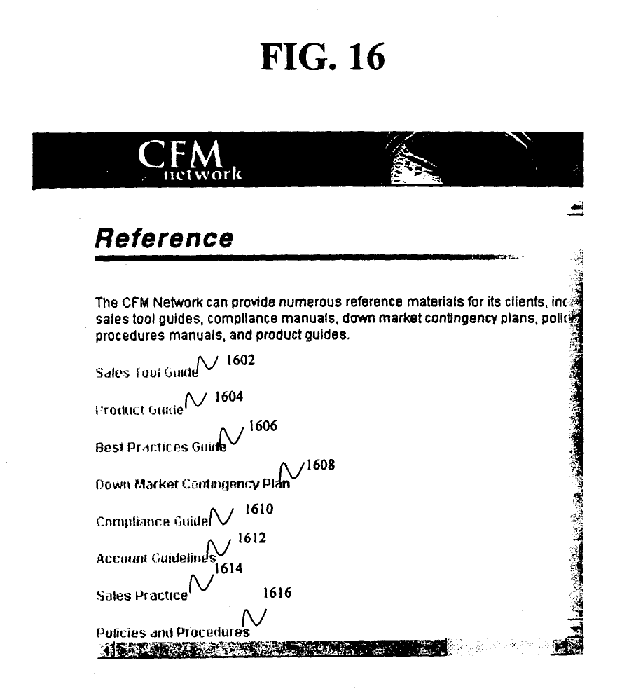

Turning now briefly to FIG. 16. FIG. 16 is an exemplary screen for listing various reference resource types. The reference resource types listed include Sales 1602, Product 1604, Best Practices 1606, Down Market Contingency Plan 1608, Compliance 1610, Account Guidelines 1612, Sales Practice 1614, and Policies and Procedures 1616. In the preferred embodiment, each listed reference type is a link or refers to links that, when selected, leads to a corresponding segment of information that supplements compliance knowledge segments of information and includes a written description pertaining to the issues addressed by the reference resource type. The segments of information may be stored on server devices 102a.

Returning now to FIG. 15. In Step 1502, the user can select a listed reference resource type. The selection corresponds to the segment of information that the user desires to use as a supplement. The selection is transmitted from computer device 106 over network 104 to server 102a using network interface 322.

In Step 1504, the server 102a can transmits a portion of the segment of information. In the preferred embodiment, the segment of information corresponding to the selected reference resource type. The segment of information is transmitted over network 104 to the computer device 106. The portion of the segment of information is provided to the user as a web page. The web page may include a list of various sections that relate to specific issues discussed in the segment of information.

In Step 1506, the user can select a link for a section of a reference resource type. The selection reflects the user's interest in obtaining supplemental information on a particular issue addressed by the reference resource type. The selection is transmitted to server 102a as a request over network 104.

In Step 1508, the server 102a can provide the user with a section of information for a section of reference resource type. In the preferred embodiment, the section of the information is provided as a web page. The section of information is for the reference resource type selected by the user. The web page may include an area for the descriptive compliance content, an area with links for navigating within the section of information, an area with a link for returning to the top of the web page for the section and the web page, and an area with a link for returning to the web page for selecting a section of a knowledge type. The server 102a transmits the web page over network 104 to a computer device 106 for display on display 318.

In the preferred embodiment, the area for the descriptive content may include descriptive text with regulatory links, and compliance links embedded therein. The descriptive text conveys the information that provides a professional with the knowledge necessary for performing a job function. The Regulatory links retrieve segments of information stored on an external server device, such as 102b and 102c. The segments of information retrieved from external server device 102b and 102c will be stripped of links referring to other segments of information. The external server 102b-102c may be associated with a regulatory agency. Compliance links retrieve a compliance segment of information stored on server device 102a that has a connection to the descriptive text surrounding the embedded training link. Reference links retrieve reference segments of information from server device 102a that are relevant and supplement the descriptive text surrounding the embedded reference link.

In Step 1510, the server 102a can determine navigation initiated within the section of information. In the preferred embodiment, the initiating navigation is accomplished through the selection of navigation links. If the server 102a determines that the navigation is for returning to the top of the section the process returns to Step 1508 where the web page providing the descriptive content is again provided. If the server 102a determines that the navigation is for navigating within the section of a reference resource the server moves to the location of information Step 1512 within the section of reference resource and then returns to Step 1510. If the server 102a determines that the navigation is for returning to the web page for selecting a section of a reference resource the process returns to Step 1502.

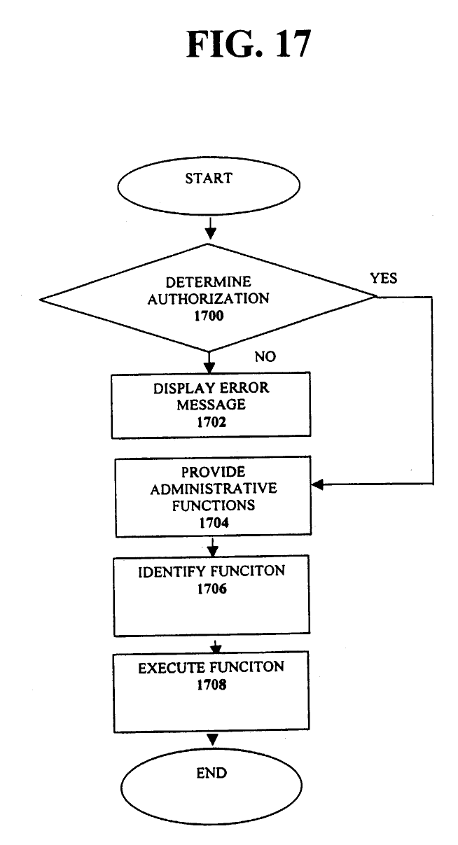

Turning to FIG. 17. FIG. 17 is a flow diagram for the method of compliance management administration. In Step 1700 the method begins in response to an administration service request by a user. In the preferred embodiment, the selection of the administration service initiates a validation process to determine whether the user has the access rights to implement the functions of the administration service. If the user does not have access rights, in step 1702 an error message will be displayed and the user will be notified that he/she lacks the necessary access rights or to contact an administrator. If the user does have access rights, in Step 1704 the user is provided with an Administrative Page listing the functions available to an administrator. The functions may include user registration and profile creation, notification, and information creation and distribution.

In Step 1706, the system can identify an administration function to perform. In the preferred embodiment, the system identifies the administrative function selected by a user. In Step 1708, the system executes the function. If user registration and profile creation function is selected, the administrator is allowed to assign access rights and training courses to be taken by the user according to job functions and professional licenses held as well as develop a user profile. The user profile may include a description of the licenses held by the user, important dates, personal information, work location, educational level, tenure with business entity, and access group. If the training notification function is selected, the user is allowed to distribute to users communications dialogs regarding updates to compliance knowledge, additional training requirements, upcoming examination, and continuing education requirements. These dialogs can be in the form of emails. If the information creation and distribution function is selected, the user is allowed to modify or add to the segments of information stored in database 216.

The present invention is described above with reference to flowchart illustrations of methods, systems and computer program products. It will be understood that each block of the flowchart illustrations, and combinations of blocks in the flowchart illustrations, can be implemented by computer program instructions. These computer program instructions may be loaded onto and stored in a computer-readable memory of a general-purpose computer, special purpose computer, or other programmable data processing apparatus to produce a machine. These computer program instructions, which execute on the computer or other programmable data processing apparatus, producing means and/or an article of manufacture including instruction means which implement the function specified in the flowchart block or blocks.

The computer program instructions may cause a series of operational steps to be performed producing a computer implemented process, such that the computer or other programmable apparatus provide steps for implementing the functions specified in the flowchart block or blocks. In the preferred, these computer program instructions are written in the Java programming language. It is to be appreciated by one of skill in the art, however, that these routines may be implemented in any of a wide variety of object oriented programming languages.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems that perform the specified functions or steps.

Although specific embodiments of the present invention have been described, it will be understood by those skilled in the art that there are other embodiments that are equivalent to the described embodiments. Accordingly it is to be understood that the invention is not to be limited by the specific illustrated embodiments, but only be the scope of the appended claims.

What is claimed is:

1) A method for providing professional training information and compliance knowledge information to networked computers, the method comprising:
obtaining login data;
providing compliance knowledge to a one of the networked computer based on the login data;
providing personalized professional training information associated with the compliance knowledge to the one of the networked computer based on the login data;
generating compliance knowledge use data associated with use of the provided compliance knowledge; and
generating personal training activity data associated with use of the provided personalized professional training information.

2) The method of claim 1, wherein the generating of the personal training activity data includes generating training progress data and training performance data.

3) The method of claim 2, further comprising recording the compliance knowledge use data, training progress data and training performance data in associated with the login data.

4) The method of claim 3, further comprising storing the recorded the compliance knowledge use data, training progress data and training performance data.

5) The method of claim 4, further comprising generating documents based on the recorded the compliance knowledge use data, training progress data and training performance data.

6) The method of claim 5, further comprising obtaining administrative instructions, and wherein the generating of documents includes generating the documents in accordance with the administration instructions.

7) The method of claim 6, further comprising storing of the generated documents in a database.

8) The method of claim 7, wherein the storing includes obtaining administration instruction from the administrator.

9) The method of claim 1, wherein the compliance knowledge includes knowledge types.

10) The method of claim 9, further comprising linking the knowledge types to one another.

11) The method of claim 9, wherein the knowledge types include a descriptive text area.

12) The method of claim 11, further comprising embedding in the knowledge type one of: a regulatory links, training links and a compliance link within the descriptive text area.

13) The method of claim 11, further comprising embedding in the personalized professional training information a communication link.

14) The method of claim 1, further comprising enabling communication between one or more users.

15) The method of claim 1, further comprising providing reference compliance knowledge based on the login data.

16) The method of claim 1, further comprising providing compliance management based on login data.

17) The method of claim 16, wherein the providing of compliance management includes assigning a profile.

18) The method of claim 16, wherein the providing of compliance management includes providing notification.

19) The method of claim 16, wherein the providing of compliance management includes creating and distributing compliance knowledge.

20) A method of doing business for providing professional training information and compliance knowledge information to networked computers, the method of doing business comprising:
obtaining login data;
providing compliance knowledge to a one of the networked computer based on the login data;
providing personalized professional training information associated with the compliance knowledge to the one of the networked computer based on the login data;
generating compliance knowledge use data associated with use of the provided compliance knowledge; and
generating personal training activity data associated with use of the provided personalized professional training information.

21) The method of doing business of claim 20, wherein the generating of the personal training activity data includes generating training progress data and training performance data.

22) The method of doing business of claim 21, further comprising recording the compliance knowledge use data, training progress data and training performance data in associated with the login data.

23) The method of doing business of claim 22, further comprising storing the recorded the compliance knowledge use data, training progress data and training performance data.

24) The method of doing business of claim 23, further comprising generating documents based on the recorded the compliance knowledge use data, training progress data and training performance data.

25) The method of doing business of claim 24, further comprising obtaining administrative instructions, and wherein the generating of documents includes generating the documents in accordance with the administration instructions.

26) The method of doing business of claim 25, further comprising storing of the generated documents in a database.

27) The method of doing business of claim 26, wherein the storing includes obtaining administration instruction from the administrator.

28) The method of doing business of claim 20, wherein the compliance knowledge includes knowledge types.

29) The method of doing business of claim 28, further comprising linking the knowledge types to one another.

30) The method of doing business of claim 28, wherein the knowledge types include a descriptive text area.

31) The method of doing business of claim 30, further comprising embedding in the knowledge type one of: a regulatory links, training links and a compliance link within the descriptive text area.

32) The method of doing business of claim 30, further comprising embedding in the personalized professional training information a communication link.

33) The method of doing business of claim 20, further comprising enabling communication between one or more users.

34) The method of doing business of claim 20, further comprising providing reference compliance knowledge based on the login data.

35) The method of doing business of claim 20, further comprising providing compliance management based on login data.

36) The method of doing business of claim 35, wherein the providing of compliance management includes assigning a profile.

37) The method of doing business of claim 35, wherein the providing of compliance management includes providing notification.

38) The method of doing business of claim 35, wherein the providing of compliance management includes creating and distributing compliance knowledge.

39) A system for providing professional training information and compliance knowledge information, the system comprising:
a computer for providing login data;
a network;
a server, coupled to the computer and the network, for:
providing compliance knowledge to a one of the networked computer based on the login data;
providing personalized professional training information associated with the compliance knowledge to the one of the networked computer based on the login data;
generating compliance knowledge use data associated with use of the provided compliance knowledge; and
generating personal training activity data associated with use of the provided personalized professional training information.

40) The system of claim 39, wherein the generating of the personal training activity data includes the server for generating training progress data and training performance data.

41) The system of claim 40, further comprising the server for recording the compliance knowledge use data, training progress data and training performance data in associated with the login data.

42) The system of claim 41, further comprising a database, coupled to the server, for storing the recorded the compliance knowledge use data, training progress data and training performance data.

43) The system of claim 42, further comprising the server for generating documents based on the recorded the compliance knowledge use data, training progress data and training performance data.

44) The system of claim 43, further comprising the computer for providing administrative instructions, and wherein the generating of documents includes the server for generating the documents in accordance with the administration instructions.

45) The system of claim 44, further comprising the database for storing of the generated documents.

46) The system of claim 45, wherein the storing includes the computer for providing administration instructions.

47) The system of claim 39, wherein the compliance knowledge includes knowledge types.

48) The system of claim 47, further comprising the server for linking the knowledge types to one another.

49) The system of claim 47, wherein the knowledge types include a descriptive text area.

50) The system of claim 49, further comprising the server for embedding in the knowledge type one of: a regulatory links, training links and a compliance link within the descriptive text area.

51) The system of claim 49, further comprising the server for embedding in the personalized professional training information a communication link.

52) The system of claim 39, further comprising the server for enabling communication between one or more users.

53) The system of claim 39, further comprising the server for providing reference compliance knowledge based on the login data.

54) The system of claim 39, further comprising the server for providing compliance management based on login data.

55) The system of claim 54, wherein the providing of compliance management includes the server for assigning a profile.

56) The system of claim 54, wherein the providing of compliance management includes the server for providing notification.

57) The system of claim 54, wherein the providing of compliance management includes the server for creating and distributing compliance knowledge.
